(19) United States
(12) Patent Application Publication
(10) Pub. No.: US 2010/0265348 A1
(43) Pub. Date: Oct. 21, 2010

(54) Systems and Methods for Image Data Transfer

(75) Inventor: Robert W. Warren, Loveland, CO (US)

Correspondence Address: Hamilton,DeSanctis & Cha (LSI), 8601 W. CROSS DRIVE, F5-301, LITTLETON, CO, 80123, US

(73) Assignee: Agere Systems Inc.

(21) Appl. No.: 12/425,596

(22) Filed: Apr. 17, 2009

(51) Int. Cl. H04N 5/228

(52) U.S. Cl. 348/222.1; 382/232; 382/195; 348/E05.024

(57) ABSTRACT

Various embodiments of the present invention provide systems and methods for efficient image data transfer and/or storage. As an example, some embodiments of the present invention provide data storage systems that include an image capture device, a storage medium and a processor. The image capture device generates a first still image and a second still image. The processor is communicably coupled to the storage medium, and generates a first compressed image and a second compressed image. The first compressed image and the second compressed image are generated by: receiving the first still image and the second still image; selecting an image portion of the first still image; identifying a similarity between the image portion of the first still image and an image portion of the second still image; indicating the similarity; and eliminating the image portion of the second still image. The processor stores the first compressed image and a second compressed image to the storage medium.

### BACKGROUND OF THE INVENTION

The present inventions are related to systems and methods for efficiently storing and/or transferring image data.

The amount of data included in an image can be significant. To allow for more efficient transfer and/or storage of such images, various approaches for image compression have been developed. In some cases, such image compression approaches rely on maintaining a single instance of duplicated image portions along with indicating where the duplication has occurred. As there may be significant duplication in any given image, substantial compression may be achieved. As the data remaining after compression decreases, the compression ratio is said to increase. In many cases, however, the size of the compressed image remains large. This can be particularly problematic in data storage and transfer scenarios that are directly impacted by the size of the compressed files.

Hence, for at least the aforementioned reasons, there exists a need in the art for advanced systems and methods for increasing the compression ratio.

### BRIEF SUMMARY OF THE INVENTION

The present inventions are related to systems and methods for efficiently storing and/or transferring image data.

Various embodiments of the present invention provide data storage systems that include an image capture device, a storage medium and a processor. The image capture device generates a first still image and a second still image. The processor is communicably coupled to the storage medium, and generates a first compressed image and a second compressed image. The first compressed image and the second compressed image are generated by: receiving the first still image and the second still image; selecting an image portion of the first still image; identifying a similarity between the image portion of the first still image and an image portion of the second still image; indicating the similarity; and eliminating the image portion of the second still image. The processor stores the first compressed image and a second compressed image to the storage medium. In some instances of the aforementioned embodiments, the image capture device is a still camera.

In one or more instances of the aforementioned embodiments, indicating the similarity includes writing an indication of the similarity to a compression file, and storing the compression file to the storage medium. In some cases, the processor regenerates the first still image and the second still image by: accessing the compression file from the storage medium; and reconstructing the second still image using the compression file. In such cases, the image portion of the first still image is used in the location of the image portion of the second still image. In particular instances of the aforementioned embodiments, the systems further include a display communicably coupled to the processor. In such instances, the processor may be operable to provide at least one of the first still image and the second still image to the display.

Other embodiments of the present invention provide methods for compressing images. The methods include: defining a scope of compression that includes at least a first still image and a second still image; selecting an image portion of the first still image; identifying a similarity between the image portion of the first still image and an image portion of the second still image; indicating the similarity; and eliminating the image portion of the second still image. In some cases, the indication of the second similarity includes a location of the second image portion of the second still image referenced to a location of the image portion of the first still image. In other cases, the indication of the similarity includes a location of the image portion of the third still image referenced to data corresponding to the second image portion of the second still image. In various instances of the aforementioned embodiments, defining a scope of compression includes co-locating the first still image and the second still image. Such co-location may include, but is not limited to, placing the two still images in the same file.

In some instances of the aforementioned embodiments, the similarity is a first similarity, the portion of the second still image is a first image portion of the second still image, and the scope of compression further includes a third still image. In such cases, the methods may further include: selecting a second image portion of the second still image; identifying a second similarity between the second image portion of the second still image and an image portion of the third still image; and indicating the second similarity and eliminating the image portion of the third still image.

In various cases, the similarity is a first similarity, wherein the image portion of the first image is a first image portion of the first still image. In such instances, the methods may further include identifying a similarity between the first image portion of the first still image and second image portion of the first still image, and indicating a second similarity and eliminating the second image portion of the first image still image. In some such cases, indicating the similarity includes writing an indication of the similarity to a compression file. The compression file may be accessed and used to reconstruct the second still image using the compression file. The image portion of the first still image is used in the location of the image portion of the second still image. In some cases, the indication of the similarity includes a location of the image portion of the second still image referenced to a location of the image portion of the first still image. In other cases, the indication of the similarity includes a location of the image portion of the second still image referenced to data corresponding to the image portion of the first still image.

Yet other embodiments of the present invention provide image storage systems that include a processor that is communicably coupled to a first memory and a second memory. The first memory includes at least a first still image and a second still image. The first memory further includes instructions executable by the processor to: (a) receive the first still image and the second still image; (b) select an image portion of the first still image; (c) identify a similarity between the image portion of the first still image and an image portion of the second still image; (d) indicate the similarity; (e) eliminate the image portion of the second still image to generate a first compressed image and a second compressed image; and (f) store the first compressed image and the second compressed image to ate second memory.

In some instances of the aforementioned embodiments, the first memory is a random access memory, and the second memory is a mechanical hard disk drive. In one or more instances of the aforementioned embodiments, the first still image and the second still image are received from a camera. In particular instances of the aforementioned embodiments, indicating the similarity includes: writing an indication of the similarity to a compression file; and storing the compression file to the second memory. In some cases, the first memory further includes instructions executable by the processor to: access the compression file from the second memory; and reconstruct the second still image using the compression file. In such cases, the image portion of the first still image is used in the location of the image portion of the second still image.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1a is a flow diagram showing a method in accordance with one or more embodiments of the present invention for compressing a scope of two or more images;

FIG. 1b is a flow diagram showing a method in accordance with some embodiments of the present invention for reconstructing compressed images;

FIG. 2a shows an exemplary set of images including similar image portions that may be compressed in accordance with various embodiments of the present invention;

FIG. 2b graphically depicts the images of FIG. 2a after compression performed in accordance with one or more embodiments of the present invention;

FIG. 3 is an image compression/decompression and storage system in accordance with various embodiments of the present invention; and

FIG. 4 is an image compression/decompression and storage system in accordance with other embodiments of the present invention.

### DETAILED DESCRIPTION OF THE INVENTION

The present inventions are related to systems and methods for efficiently storing and/or transferring image data.

Various embodiments of the present invention provide data storage systems that include an image capture device, a storage medium and a processor. The image capture device generates a first still image and a second still image. As used herein, the phrase “image capture device” is used in its broadest sense to mean any device or mechanism capable of capturing an image. Thus, for example, an image capture device may be a camera, a scanner, a copier, a fax machine or the like. Based upon the disclosure provided herein, one of ordinary skill in the art will recognize a variety of image capture devices that may be used in relation to different embodiments of the present invention. The processor is communicably coupled to the storage medium, and generates a first compressed image and a second compressed image. As used herein, the term “processor” is used in its broadest sense to mean any circuit or device that is capable of executing instruction and providing an output. Such a processor may be, but is not limited to, a microprocessor or a digital signal processor. Based upon the disclosure provided herein, one of ordinary skill in the art will recognize a variety of processors that may be used in relation to different embodiments of the present invention. The phrase “storage medium” is used in its broadest sense to mean any device or system capable of maintaining information. As such, a storage medium may include, but is not limited to, a hard disk drive, a random access memory, a flash memory device, or the like. Based upon the disclosure provided herein, one of ordinary skill in the art will recognize a variety of storage media that may be used in relation to different embodiments of the present invention. The first compressed image and the second compressed image are generated by: receiving the first still image and the second still image; selecting an image portion of the first still image; identifying a similarity between the image portion of the first still image and an image portion of the second still image; indicating the similarity; and eliminating the image portion of the second still image. The processor stores the first compressed image and a second compressed image to the storage medium. In some instances of the aforementioned embodiments, the image capture device is a still camera. As used herein, the phrase “image portion” is used in its broadest sense to mean any subset of an image. In some cases, an image portion may include a rectangular region consisting of a number of pixels of a larger image.

As used herein, the term “similarity” is used in its broadest sense to mean a correlation between two regions. Thus, for example, where an image portion consists of sixteen pixels, a “similarity” may be found where thirteen of the sixteen pixels match. Based upon the disclosure provided herein, one of ordinary skill in the art will recognize a variety of basis upon which two regions may be considered similar or to have a similarity. Some embodiments of the present invention provide for increased compression by allowing for similarities to be identified across images. In this way, a dictionary or compression file may be developed that includes only a limited amount of data for image portions along with indications of where the data for the image portions are used across a number of images.

Such embodiments may include defining a scope of compression. As used herein, the phrase “scope of compression” is used in its broadest sense to mean any identification or grouping of two or more images that are to be compressed together and rely on the same dictionary or compression file. In some cases, a higher degree of compression is achievable where the included images exhibit overall similarity. Thus, to achieve a higher degree of compression, defining the scope of compression may include, but is not limited to, selecting images that are captured or created within a certain time frame. Alternatively, defining the scope of compression may include, but is not limited to, selecting images that are maintained in a common folder or directory structure. Based upon the disclosure provided herein, one of ordinary skill in the art will recognize a variety of approaches for defining the scope of compression that may be used in relation to different embodiments of the present invention.

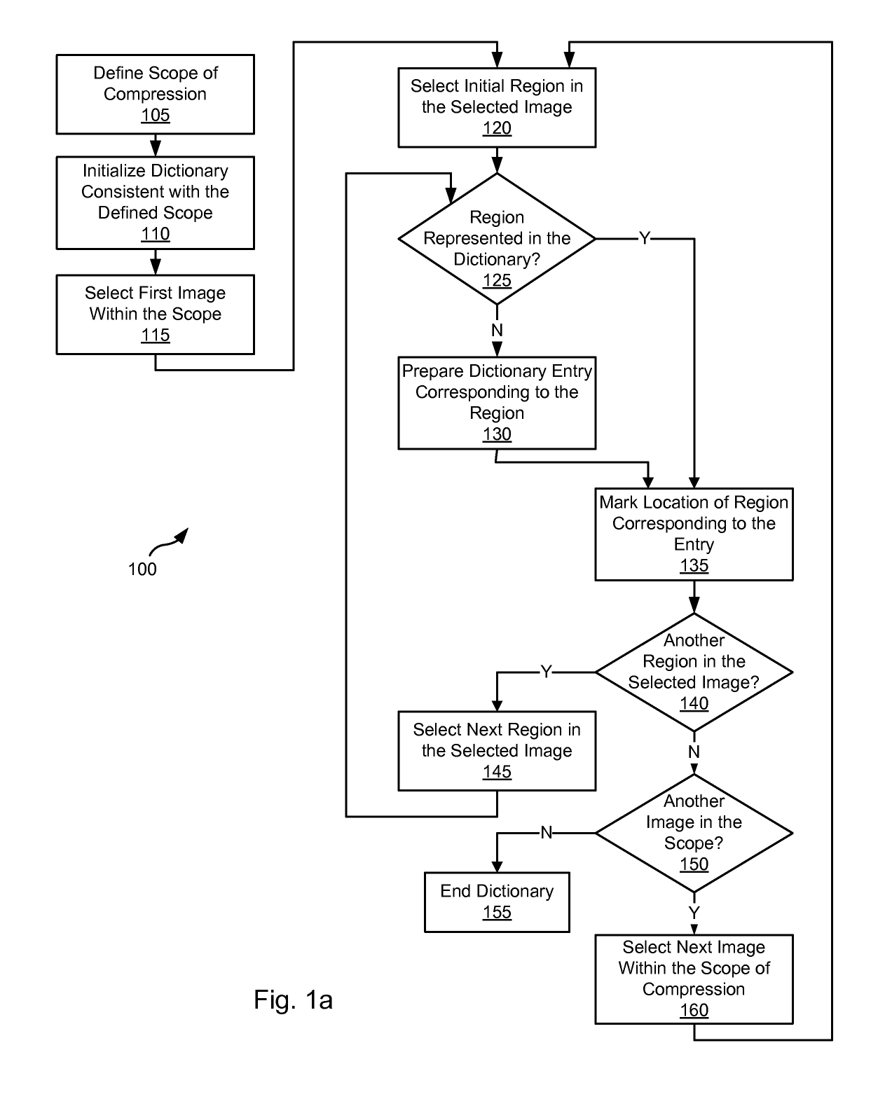

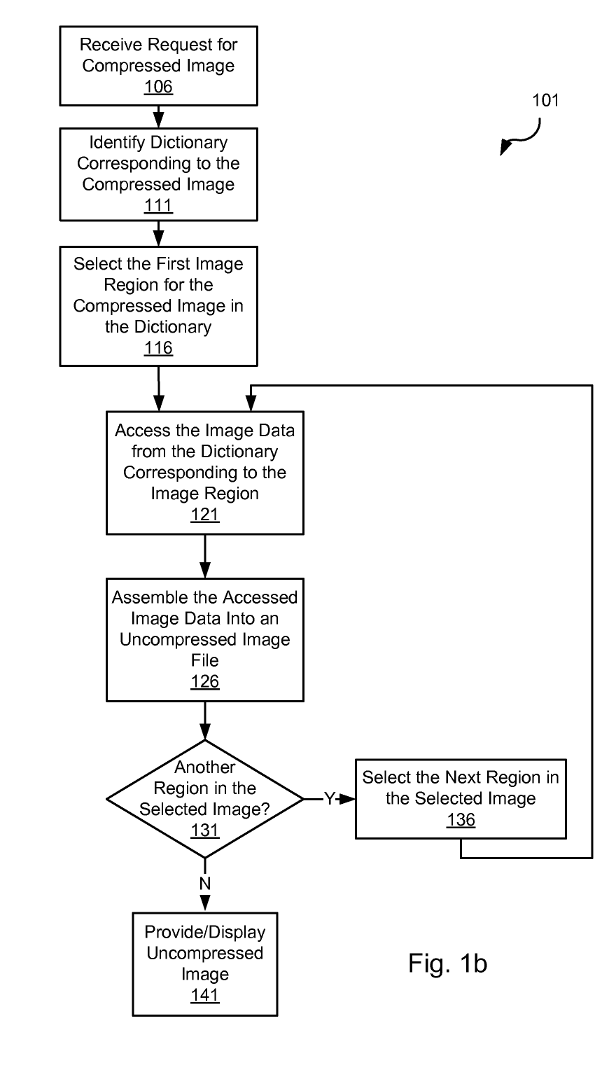

Turning to FIG. 1a, a flow diagram 100 shows a method in accordance with one or more embodiments of the present invention for compressing a scope of two or more sets of image data. Following flow diagram 100, the scope of compression is defined (block 105). Defining the scope of compression may be done in a number of ways. For example, a file including a number of still images may be selected. In such a case, defining the scope for compression may include selecting the file with the still images. As another example, the scope of compression may be selected based upon time stamps associated with various still images. A dictionary or compression file consistent with the defined scope is initialized (block 110), and a first image within the defined scope of compression is selected (block 115).

An initial image portion or region of the selected image is selected (block 120). It is then determined whether the selected image portion is represented in the dictionary (block 125). Where the image portion is not represented in the dictionary (block 125), a dictionary entry corresponding to the image portion is prepared (block 130). This entry may include, for example, the data of the image portion may be stored. Thus, for example, where the image region is a four by four pixel region, data corresponding to the sixteen pixels is stored. After preparing the dictionary entries (block 130) or where the region is represented in the dictionary (block 125), the current location of the selected image region is recorded in the dictionary corresponding to the data for the selected image region (block 135). Thus, where the image region was not included in the dictionary (block 125), the location of the selected image region is recorded in relation to the newly written data for the selected image region. Alternatively, where the image region was included in the dictionary (block 125), the location of the selected image region is recorded in relation to image data previously written to the dictionary that was identified as similar to that of the selected image region. Of note, where the image region was included in the dictionary (block 125), the data corresponding to the image region is not written again, but rather is eliminated.

It is then determined whether there is another image region of the selected image that remains to be processed (block 140). The processing generally continues until all image regions have been compared. Where there is another image region remaining for processing (block 140), the next image region in the selected image is selected (block 145), and the processes of blocks 125 through 140 are repeated. Alternatively, where all of the image regions for the selected image have been processed (block 140), it is determined whether there is another image within the scope of compression (block 150). Where all of the images in the scope of compression have been processed (block 150), the compression process is completed and the dictionary is closed (block 155). Alternatively, where another image remains for processing (block 150), the next image within the scope of compression is selected (block 160). The processes of blocks 120 through 150 are repeated for the next image. The processes of flow diagram 100 are thus repeated until all regions of each image within the scope of compression have been fully processed. When completed, the dictionary represents all of the images and includes only a fraction of the overall data of the images.

Turning to FIG. 1b, a flow diagram 101 shows a method in accordance with some embodiments of the present invention for reconstructing compressed images. Following flow diagram 101, a request is received for a particular image that was previously compressed (block 106). A dictionary including the data corresponding to the requested image is identified (block 111). To facilitate this, a dictionary when initialized may be prepared to include a list of images included in the scope of compression. Alternatively, a file may be generated for the particular image that includes a pointer to the dictionary used to reconstruct the image. Based upon the disclosure provided herein, one of ordinary skill in the art will recognize other approaches that may be used in relation to different embodiments of the present invention for marking and identifying dictionary files associated with compressed image files.

The first image region corresponding to the selected compressed image is identified in the dictionary (block 116). The image data corresponding to the image region is accessed from the dictionary (block 121) and written to a corresponding location in an uncompressed image file (block 126). It is then determined whether there is another image region remaining for processing in the selected image (block 131). Where there is another image region remaining for processing (block 131), the next image region is selected (block 136) and the processes of blocks 121 through 131 are repeated for the newly selected image region. This process continues until all image regions for the selected image have been processed (block 131) at which time the uncompressed image may be transferred, displayed or re-stored depending upon the desired actions (block 141).

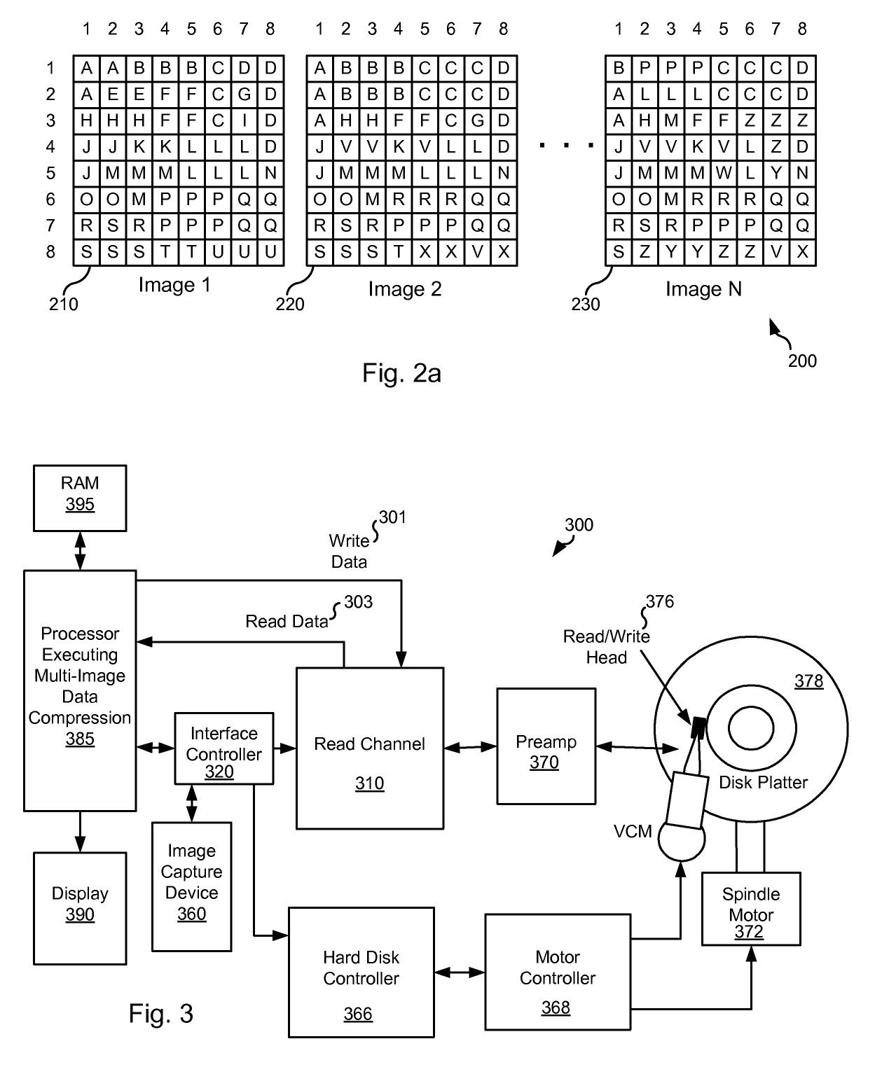

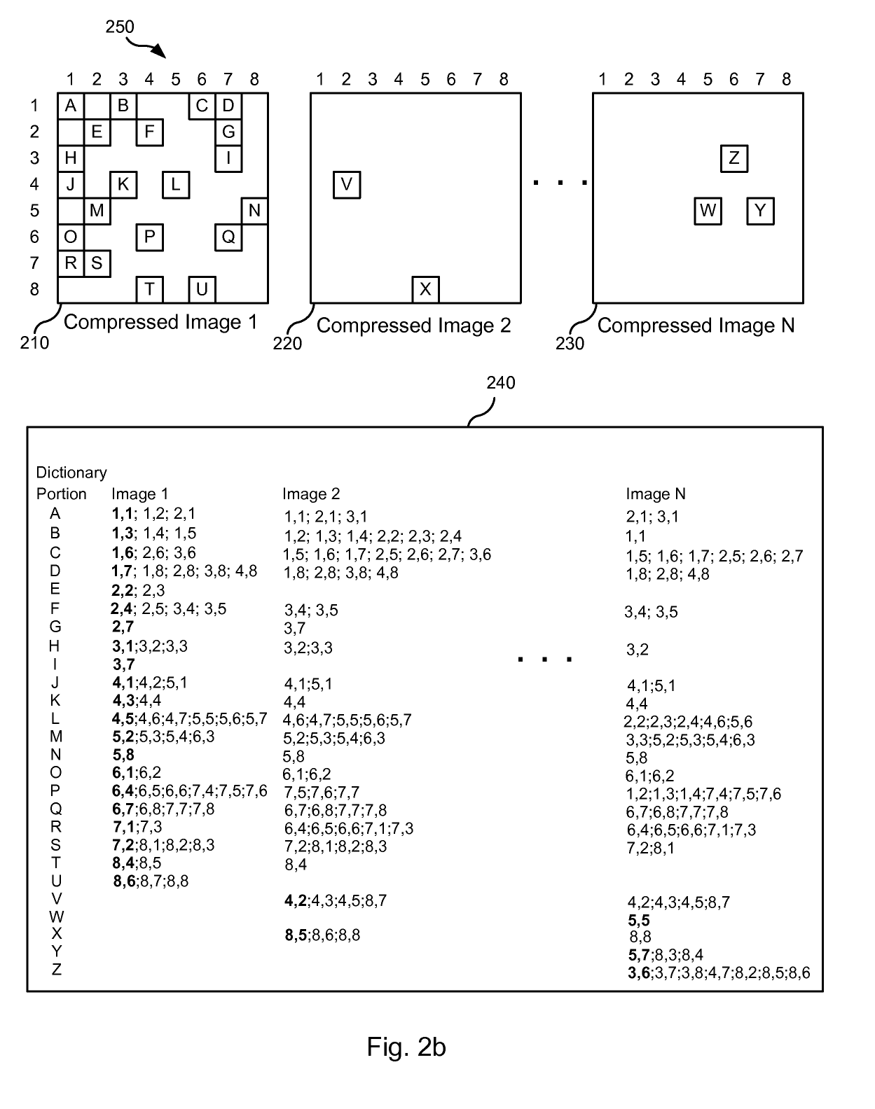

Turning to FIG. 2a, an exemplary set of images 200 is shown that include similar image portions that may be compressed in accordance with various embodiments of the present invention. As shown, images 210, 220, 230 each includes sixty four image regions arranged in rectangular pattern and each identified by a Cartesian coordinate (e.g., x,y). It should be noted that the number of image regions and the size of images 210, 220, 230 and image regions may vary depending upon the particular application and that the numbers discussed herein are merely exemplary. In addition, it should be noted that more or fewer than three images may be compressed using embodiments of the present invention. For demonstration purposes, each image region is identified by a capital letter, and image regions including the same capital letter are similar. Again, similarity may be defined for a given application and indicates some level of commonality between image regions. Where a low degree of commonality between image regions is allowed, a higher degree of compression is achievable. However, the accuracy of the uncompressed image may be low. In contrast, a higher degree of accuracy in the uncompressed image may be achieved by requiring a higher degree of commonality before identifying two image regions as similar or having a similarity. Increasing the degree of commonality, however, reduces the level of compression that can be achieved.

Turning to FIG. 2b, compression of the images of FIG. 2a is graphically portrayed in accordance with one or more embodiments of the present invention. As shown, in image 210 there are multiple instances of image region A. In the compression process, data corresponding to image region A is stored to a dictionary 240 along with the three locations in image region A (1,1;1,2 and 2,1) where the data is included in image 210. In addition, the three locations in image 220 (1,1;2,1 and 3,1) where the data is included, and the two locations in image 230 (2,1 and 3,1) are recorded to dictionary 240. The first instance of a given image region is indicated in bold. Similarly, there are multiple instances of image region B. In the compression process, data corresponding to image region B is stored to a dictionary 240 along with the three locations in image 210 (1,3;1,4 and 1,5) where the data is included. In addition, the six locations in image 220 (1,2; 1,3;1,4;2,2;2,3;2,4) where the data is included, and the single location in image 230 (1,1) are recorded to dictionary 240. There are multiple instances of image region C. In the compression process, data corresponding to image region C is stored to a dictionary 240 along with the three locations in image 210 (1,6;2,6 and 3,6) where the data is included. In addition, the seven locations in image 220 (1,5;1,6;1,7;2,5;2,6;2,7 and 3,6) where the data is included, and the six locations in image 230 (1,5;1,6;1,7;2,5;2,6;2,7) are recorded to dictionary 240.

There are multiple instances of image region D. In the compression process, data corresponding to image region D is stored to a dictionary 240 along with the five locations in image 210 (1,7;1,8; 2,8; 3,8 and 4,8) where the data is included. In addition, the four locations in image 220 (1,8;2,8;3,8 and 4,8) where the data is included, and the three locations in image 230 (1,8;2,8 and 4,8) are recorded to dictionary 240. There are multiple instances of image region E. In the compression process, data corresponding to image region E is stored to a dictionary 240 along with the two locations in image 210 (2,2 and 2,3) where the data is included. There are no instances of image region E in either image 220 or image 230. Thus, there are no locations corresponding to image region E recorded in the compressed images. There are multiple instances of image region F. In the compression process, data corresponding to image region F is stored to a dictionary 240 along with the four locations in image 210 (2,4; 2,5; 3,4 and 3,5) where the data is included. In addition, the two locations in image 220 (3,4 and 3,5) where the data is included, and the two locations in image 230 (3,4 and 3,5) are recorded to dictionary 240. There are multiple instances of image region G. In the compression process, data corresponding to image region G is stored to a dictionary 240 along with the single location in image 210 (2,7) where the data is included. In addition, the single location in image 220 (3,7) where the data is included is recorded to dictionary 240. There are no instances of image region G in image 230. Thus, there are no locations corresponding to image region G recorded in the compressed image.

There are multiple instances of image region H. In the compression process, data corresponding to image region H is stored to a dictionary 240 along with the three locations in image 210 (3,1;3,2 and 3,3) where the data is included. In addition, the two locations in image 220 (3,2 and 3,3) where the data is included, and the single location in image 230 (3,2) are recorded to dictionary 240. There is only a single instance of image region I. In the compression process, data corresponding to image region I is stored to a dictionary 240 along with the single location in image 210 (3,7) where the data is included. There are no instances of image region I in either image 220 or image 230. Thus, there are no locations corresponding to image region I recorded in the compressed images. There are multiple instances of image region J. In the compression process, data corresponding to image region J is stored to a dictionary 240 along with the three locations in image 210 (4,1;4,2 and 5,1) where the data is included. In addition, the two locations in image 220 (4,1 and 5,1) where the data is included, and the two locations in image 230 (4,1 and 5,1) are recorded to dictionary 240. There are multiple instances of image region K. In the compression process, data corresponding to image region K is stored to a dictionary 240 along with the two locations in image 210 (4,3 and 4,4) where the data is included. In addition, the single location in image 220 (4,4) where the data is included, and the single location in image 230 (4,4) are recorded to dictionary 240.

There are multiple instances of image region L. In the compression process, data corresponding to image region L is stored to a dictionary 240 along with the six locations in image 210 (4,5;4,6;4,7;5,5;5,6 and 5,7) where the data is included. In addition, the five locations in image 220 (4,6;4,7;5,5;5,6 and 5,7) where the data is included, and the five locations in image 230 (2,2;2,3;2,4;4,6 and 5,6) are recorded to dictionary 240. There are multiple instances of image region M. In the compression process, data corresponding to image region M is stored to a dictionary 240 along with the four locations in image 210 (5,2;5,3;5,4 and 6,3) where the data is included. In addition, the four locations in image 220 (5,2;5,3;5,4 and 6,3) where the data is included, and the five locations in image 230 (3,3;5,2;5,3;5,4 and 6,3) are recorded to dictionary 240. There are multiple instances of image region N. In the compression process, data corresponding to image region N is stored to a dictionary 240 along with the single location in image 210 (5,8) where the data is included. In addition, the single location in image 220 (5,8) and the single location in image 230 (5,8) where the data is included are recorded to dictionary 240.

There are multiple instances of image region O. In the compression process, data corresponding to image region O is stored to a dictionary 240 along with the two locations in image 210 (6,1 and 6,2) where the data is included. In addition, the two locations in image 220 (6,1 and 6,2) where the data is included, and the two locations in image 230 (6,1 and 6,2) are recorded to dictionary 240. There are multiple instances of image region P. In the compression process, data corresponding to image region P is stored to a dictionary 240 along with the seven locations in image 210 (6,4;6,5;6,6;7,4;7,5;7,6 and 8,5) where the data is included. In addition, the three locations in image 220 (7,4;7,5 and 7,6) where the data is included, and the three locations in image 230 (7,4;7,5 and 7,6) are recorded to dictionary 240. There are multiple instances of image region Q. In the compression process, data corresponding to image region Q is stored to a dictionary 240 along with the four locations in image 210 (6,7;6,8;7,7 and 7,8) where the data is included. In addition, the four locations in image 220 (6,7;6,8;7,7 and 7,8) where the data is included, and the four locations in image 230 (6,7;6,8;7,7 and 7,8) are recorded to dictionary 240. There are multiple instances of image region R. In the compression process, data corresponding to image region R is stored to a dictionary 240 along with the two locations in image 210 (7,1 and 7,3) where the data is included. In addition, the five locations in image 220 (6,4;6,5;6,6;7,1 and 7,3) where the data is included, and the five locations in image 230 (6,4;6,5;6,6;7,1 and 7,3) are recorded to dictionary 240.

There are multiple instances of image region S. In the compression process, data corresponding to image region S is stored to a dictionary 240 along with the four locations in image 210 (7,2;8,1;8,2 and 8,3) where the data is included. In addition, the four locations in image 220 (7,2;8,1;8,2 and 8,3) where the data is included, and the two locations in image 230 (7,2 and 8,1) are recorded to dictionary 240. There are multiple instances of image region T. In the compression process, data corresponding to image region T is stored to a dictionary 240 along with the two locations in image 210 (8,4 and 8,5) where the data is included. In addition, the single location in image 220 (8,4) where the data is included is recorded to dictionary 240. There are no instances of image region T in image 230. Thus, there are no locations corresponding to image region T recorded in the compressed image. There are multiple instances of image region U. In the compression process, data corresponding to image region U is stored to a dictionary 240 along with the three locations in image 210 (8,6;8,7 and 8,8) where the data is included. There are no instances of image region U in either image 220 or image 230. Thus, there are no locations corresponding to image region U recorded in the compressed images.

There are multiple instances of image region V. In the compression process, data corresponding to image region V is stored to a dictionary 240 along with the four locations in image 220 (4,2;4,3;4,5 and 8,7) where the data is included. In addition, the four locations in image 230 (4,2;4,3;4,5 and 8,7) are recorded to dictionary 240. There are no instances of image region V in image 210. Thus, there are no locations corresponding to image region V recorded in the compressed image. There is only a single instance of image region W. In the compression process, data corresponding to image region W is stored to a dictionary 240 along with the single location in image 230 (5,5) where the data is included. There are no instances of image region W in either image 210 or image 220. Thus, there are no locations corresponding to image region W recorded in the compressed images. There are multiple instances of image region X. In the compression process, data corresponding to image region X is stored to a dictionary 240 along with the three locations in image 220 (8,5;8,6 and 8,8) where the data is included. In addition, the single location in image 230 (8,8) is recorded to dictionary 240. There are no instances of image region X in image 210. Thus, there are no locations corresponding to image region X recorded in the compressed image.

There are instances of image region Y. In the compression process, data corresponding to image region Y is stored to a dictionary 240 along with the three locations in image 230 (5,7;8,3 and 8,4) where the data is included. There are no instances of image region Y in either image 210 or image 220. Thus, there are no locations corresponding to image region Y recorded in the compressed images. There are multiple instances of image region Z. In the compression process, data corresponding to image region Z is stored to a dictionary 240 along with the five locations in image 230 (3,6;3,7;3,7;4,7;8,2;8,5 and 8,6) where the data is included. There are no instances of image region Z in either image 210 or image 220. Thus, there are no locations corresponding to image region Z recorded in the compressed images. The number of image regions remaining in images 210, 220, 230 as shown in FIG. 2b represents the amount of actual image data remaining after the compression process completes.

Turning to FIG. 3, an image compression/decompression and storage system 300 is depicted in accordance with various embodiments of the present invention. Image compression/decompression and storage system 300 includes a processor 385 executing multi-image data compression. Instructions for performing the multi-image data compression are maintained in a random access memory 395 communicably coupled to processor 385. The instructions may be more permanently maintained on a magnetic storage medium 378. Processor 385 is also communicably coupled to a display 390 that is capable of receiving and displaying uncompressed image data provided by processor 385. Processor 385 is capable of receiving still images from an image capture device 360. Such an image capture device 360 may be communicably coupled to processor 385 via an interface controller 320.

Image compression/decompression and storage system 300 includes a hard disk drive that is communicably coupled to processor 385 via interface controller 320. The hard disk drive 300 includes a read channel circuit 310 that is communicably coupled to a read/write head assembly 376 via a preamplifier 370. Read/write head assembly 376 is disposed in relation to a magnetic storage medium (disk platter) 378 and is capable of sensing information stored on magnetic storage medium 378. The hard disk drive further includes a hard disk controller 366, a motor controller 368, and a spindle motor 372. The data on storage medium 378 consists of groups of magnetic signals that may be detected by read/write head assembly 376 when the assembly is properly positioned over storage medium 378.

In a typical read operation, read/write head assembly 376 is accurately positioned by motor controller 368 over a desired data track on storage medium 378. Motor controller 368 both positions read/write head assembly 376 in relation to storage medium 378 and drives spindle motor 372 by moving read/write head assembly to the proper data track on storage medium 378 under the direction of hard disk controller 366. Spindle motor 372 spins storage medium 378 at a determined spin rate (RPMs). Once read/write head assembly 378 is positioned adjacent the proper data track, magnetic signals representing data on storage medium 378 are sensed by read/write head assembly 376 as storage medium 378 is rotated by spindle motor 372. The sensed magnetic signals are provided as a continuous, minute analog signal representative of the magnetic data on storage medium 378. This minute analog signal is transferred from read/write head assembly 376 to read channel module 364 via preamplifier 370. Preamplifier 370 is operable to amplify the minute analog signals accessed from storage medium 378. In turn, read channel module 310 decodes and digitizes the received analog signal to recreate the information originally written to storage medium 378. This data is provided as read data 303 to processor 385. A write operation is substantially the opposite of the preceding read operation with write data 301 being provided to read channel module 710 by processor 385. This data is then encoded and written to storage medium 378.

In operation, a number of still images are captured using image capture device 360. These still images are stored in uncompressed form to random access memory 395 and/or magnetic storage medium 378. The uncompressed images may then be gathered in defined groups and compressed using the multi-image compression of processor 385. The compressed images may then be stored to storage medium 378. In some cases, the multi-image compression may be done similar to that described above in relation to FIG. 1a. When requested, the compressed images may be accessed from storage medium 378 and reconstructed. In some cases, the images may be reconstructed similar to that discussed in relation to FIG. 1b. The uncompressed images may then be provided to display 390 where they are displayed.

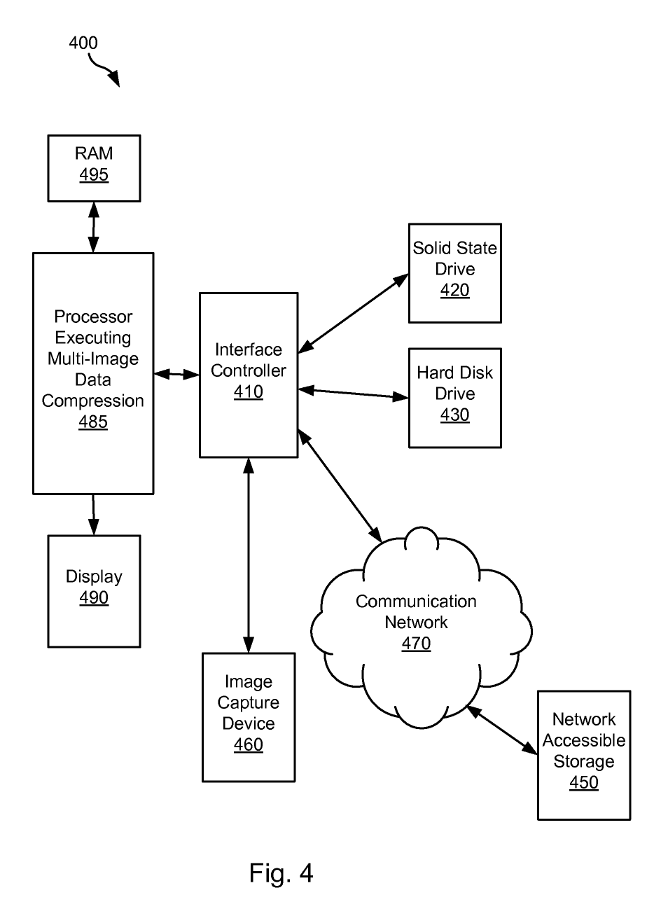

Turning to FIG. 4 an image compression/decompression and storage system 400 is shown in accordance with other embodiments of the present invention. Image compression/decompression and storage system 400 includes a processor 485 executing multi-image data compression. Instructions for performing the multi-image data compression are maintained in a random access memory 495 communicably coupled to processor 485. The instructions may be more permanently maintained on a solid state drive 420, a hard disk drive 430, or a network accessible storage device 450. Solid state drive 420 and hard disk drive 430 may be communicably coupled to processor 485 via an interface controller 410. Network accessible storage 450 may be communicably coupled to processor 485 via an interface controller 410 and a communication network 470. Processor 485 is capable of receiving still images from an image capture device 460. Such an image capture device 460 may be communicably coupled to processor 485 via interface controller 410. Processor 485 is also communicably coupled to a display 490 that is capable of receiving and displaying uncompressed image data provided by processor 490.

In operation, a number of still images are captured using image capture device 460. These still images are stored in uncompressed form to random access memory 495, solid state drive 420, hard disk drive 430, and/or network accessible storage 450. The uncompressed images may then be gathered in defined groups and compressed using the multi-image compression of processor 485. The compressed images may then be stored to one or more of solid state drive 420, hard disk drive 430, and/or network accessible storage 450. In some cases, the multi-image compression may be done similar to that described above in relation to FIG. 1a. When requested, the compressed images may be accessed from one or more of solid state drive 420, hard disk drive 430, and/or network accessible storage 450 and reconstructed. In some cases, the images may be reconstructed similar to that discussed in relation to FIG. 1b. The uncompressed images may then be provided to display 490 where they are displayed.

In conclusion, the invention provides novel systems, devices, methods and arrangements for efficiently handling image data. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data storage system, wherein the data storage system comprises:
an image capture device, wherein the image capture device generates a first still image and a second still image;
a storage medium;
a processor communicably coupled to the storage medium, wherein the processor generates a first compressed image and a second compressed image by:
(a) receiving the first still image and the second still image;
(b) selecting an image portion of the first still image;
(c) identifying a similarity between the image portion of the first still image and an image portion of the second still image;
(d) indicating the similarity; and
(e) eliminating the image portion of the second still image; and
wherein the processor stores the first compressed image and a second compressed image to the storage medium.

2. The data storage system of claim 1, wherein the image capture device is a still camera.

3. The data storage system of claim 1, wherein indicating the similarity includes:
writing an indication of the similarity to a compression file; and
storing the compression file to the storage medium.

4. The data storage system of claim 3, wherein the processor regenerates the first still image and the second still image by:
accessing the compression file from the storage medium; and
reconstructing the second still image using the compression file, wherein the image portion of the first still image is used in the location of the image portion of the second still image.

5. The data storage system of claim 4, wherein the system further comprises:
a display communicably coupled to the processor; and
wherein the processor is operable to provide at least one of the first still image and the second still image to the display.

6. A method for compressing images, the method comprising:
defining a scope of compression, wherein the scope of compression includes at least a first still image and a second still image;
selecting an image portion of the first still image;
identifying a similarity between the image portion of the first still image and an image portion of the second still image; and
indicating the similarity and eliminating the image portion of the second still image.

7. The method of claim 6, wherein the similarity is a first similarity, wherein the image portion of the first image is a first image portion of the first still image, and wherein the method further comprises:
identifying a similarity between the first image portion of the first still image and second image portion of the first still image; and
indicating a second similarity and eliminating the second image portion of the first image still image.

8. The method of claim 6, wherein indicating the similarity includes:
writing an indication of the similarity to a compression file.

9. The method of claim 8, wherein the method further comprises:
accessing the compression file;
reconstructing the second still image using the compression file, wherein the image portion of the first still image is used in the location of the image portion of the second still image.

10. The method of claim 8, wherein the indication of the similarity includes:
a location of the image portion of the second still image referenced to a location of the image portion of the first still image.

11. The method of claim 8, wherein the indication of the similarity includes:
a location of the image portion of the second still image referenced to data corresponding to the image portion of the first still image.

12. The method of claim 6, wherein the similarity is a first similarity, wherein the image portion of the second still image is a first image portion of the second still image, wherein the scope of compression further includes a third still image, and wherein the method further comprises:
selecting a second image portion of the second still image;
identifying a second similarity between the second image portion of the second still image and an image portion of the third still image; and
indicating the second similarity and eliminating the image portion of the third still image.

13. The method of claim 12, wherein the indication of the second similarity includes:
a location of the second image portion of the second still image referenced to a location of the image portion of the first still image.

14. The method of claim 12, wherein the indication of the similarity includes:
a location of the image portion of the third still image referenced to data corresponding to the second image portion of the second still image.

15. The method of claim 6, wherein defining a scope of compression includes:
co-locating the first still image and the second still image.

16. An image storage system, the image storage system comprising:
a processor communicably coupled to a first memory and a second memory;
a first memory, wherein the first memory includes at least a first still image and a second still image, and wherein the first memory includes instructions executable by the processor to:
(a) receive the first still image and the second still image;
(b) select an image portion of the first still image;
(c) identify a similarity between the image portion of the first still image and an image portion of the second still image;
(d) indicate the similarity;
(e) eliminate the image portion of the second still image to generate a first compressed image and a second compressed image; and
(f) store the first compressed image and the second compressed image to ate second memory.

17. The system of claim 16, wherein the first memory is a random access memory, and wherein the second memory is a mechanical hard disk drive.

18. The system of claim 16, wherein the first still image and the second still image are received from a camera.

19. The system of claim 16, wherein indicating the similarity includes:
writing an indication of the similarity to a compression file; and
storing the compression file to the second memory.

20. The system of claim 19, wherein the first memory further includes instructions executable by the processor to:
access the compression file from the second memory; and
reconstruct the second still image using the compression file, wherein the image portion of the first still image is used in the location of the image portion of the second still image.
